(19) United States
(12) Patent Application Publication
(10) Pub. No.: US 2026/0063603 A1
(43) Pub. Date: Mar. 5, 2026

(54) PROCESS FOR DIFFERENTIATION OF HIGH-VALUE NATURAL ESSENTIAL OIL-BASED AROMA CHEMICALS FROM SYNTHETIC ANALOGUES

(71) Applicant: Council of Scientific and Industrial Research, New Delhi (IN)

(72) Inventors: Chandan Singh CHANOTIYA, Lucknow (IN); Anju Kumari YADAV, Lucknow (IN); Shanmugam Pragadheesh VADAKKUPUDHUPALAYAM, Lucknow (IN); Prasanta Kumar ROUT, Lucknow (IN); Manoj SEMWAL, Lucknow (IN); Ashween Deepak NANNAWARE, Lucknow (IN); Prabodh Kumar TRIVEDI, Lucknow (IN)

(73) Assignee: Council of Scientific and Industrial Research, New Delhi (IN)

(21) Appl. No.: 19/318,020

(22) Filed: Sep. 3, 2025

(30) Foreign Application Priority Data
Sep. 5, 2024 (IN) 202411067391

(51) Int. Cl. G01N 30/86; G01N 30/02; G01N 30/72; G01N 30/78

(52) U.S. Cl. CPC G01N 30/8631; G01N 30/7206; G01N 30/78; G01N 2030/025

(57) ABSTRACT

The present invention relates to the process of differentiation of natural (−)-menthol from synthetic menthol using the GC-MS technique. First, menthol is solubilized in organic solvents such as hexane, dichloromethane, methanol, ethanol, etc. Then, the solution is injected through GC-MS and analytical parameters are set in such a manner that the major compound menthol is not detected under the operating conditions. As a result, peaks of interest get enhanced; the baseline is separated and detected in a single quadrupole mass spectrometer. The natural (−)-menthol contained p-menthenol as its unique identifier, along with other common impurity peaks such as p-menthenone and p-menthanol isomers. On the contrary, synthetic menthol did not contain p-menthenol as a distinguishing marker. The process is very easy, economical and quickly differentiates the natural menthol through GC-MS modified technique.

### CROSS-REFERENCE TO RELATED APPLICATIONS

This application claims priority to Indian Patent Application No. 202411067391, filed on Sep. 5, 2024, the subject matter of which is incorporated by reference.

### FIELD OF THE INVENTION

The present invention relates to an efficient and economical process for the differentiation of high-value natural essential oil-based aroma chemicals from synthetic analogues. Particularly, the present invention relates to the process of differentiating the menthol of natural origin from its synthetic analogue using the Gas Chromatography Mass Spectrometry (GC-MS) technique.

### BACKGROUND OF THE INVENTION

Despite the massive demand for natural essential oils and their aroma chemicals globally, the commodity has been a prime subject of debate for economically motivated adulteration (EMA) or food fraud. It occurs when addition or substitution is performed intentionally to adjust the proportion of a marker ingredient or part of a composition.

In the majority, these are manufactured through synthetic routes, resulting in high product carbon footprints or CO₂ equivalents in total greenhouse gas emissions. However, often getting mixed isomers with different chirality is no longer challenging for synthetic chemists. For example, natural menthol finds many applications in consumer products like gum, candy, chocolate, etc.

Alternatively, on an industrial scale, menthol synthesis takes place starting from m-cresol (Symrise) and citral (BASF), both fossil-based processes, with the only renewable process starting from myrcene (Takasago). The price of menthol depends on its physical state ranging from bold crystals or rice crystals to powdered state.

Since there exists an efficient production of these chemicals from efficient operations at the industrial level, synthetically prepared options have added advantage in mitigating the global gap between supply and demand. For instance, citral is produced on a large scale synthetically from relatively cheap fossil-derived isobutene and formaldehyde. Some unscrupulous companies have previously mixed or substituted natural menthol with fossil-based menthol; thus, the labels represented the product composition as natural, indicating, in part, incorrect declaration.

In addition, replacing the plant biosynthesized aroma chemicals with fossil-derived chemicals lowered the cost of production, making a good business profit going to the companies. Furthermore, the worst part of such practice is that the fraud is designed to avoid detection in the most advanced instruments. However, minimal knowledge of analytical methodologies, the kind of adulterations, and the limitations of techniques for authentication of essential oils and aroma chemicals is available. Moreover, consumer's preference for nature is at stake due to the absence of quantitative traceability tools.

The entire Indian mint industry including the mint farming community is facing the challenge of ever-growing import of synthetic menthol into the country. As a result, over fifty lakh farmers are struggling to survive in the competitive market. Moreover, the absence of regulatory standards or methods for distinction on compound origin is helping the import.

The bio-based index evaluation is the only technique available to date for authentication of the natural origin of samples/compounds. Bio based evaluation of the samples is done by quantification of ¹⁴C content, which is reported in the percentage of modern carbon (pMC) values. Accelerator Mass Spectrometry (AMS) is used for this analysis.

Reference may be made to the journal “Science of The Total Environment, Volume 908, 2024,168357” which discloses the accelerator mass spectrometer (AMS) analysis that revealed a distinction between natural and fossil-derived citral and its blends in Cymbopogon essential oils.

Reference may be made to the journal “Nuclear Inst. Method Phys. Res. B. 2015, 361, 115” which discloses the combustion of Processed samples in automated graphitization equipment (AGE), and converted into graphite powder for enabling AMS measurements to quantify ¹⁴C/¹²C ratio.

Reference may be made to the Journal “Nuclear Inst. Method. Phys. Res. B. 2019, 438, 124” which discloses the use of an ion accelerator-based AMS system for the quantification of ¹⁴C/¹²C present in each of the samples.

But, this AMS machine requires a big infrastructure, manpower, a sophisticated working environment, laborious and tedious maintenance procedures, etc. Moreover, it is a high-cost input technique with only a single functional accelerator in India to date. Most industries depend on establishments situated abroad with an analysis charge is more than 400-600 US$ per sample. Hence, there is an urgent need for eco-friendly and low-cost existing test methods to address the problem of young entrepreneurs along with the problem faced by the cosmetics and food industries.

To overcome the drawbacks mentioned in the aforesaid prior arts, present invention provides technique of GC-MS is an easy, cheap and widely available process and based on only a simple analysis step, whereas bio-based index using percent Modern Carbon (pMC) calculation is very tedious, very costly and very limited establishment available and a three-step process such as tedious sample preparation; detection; and finally, calculation.

### OBJECT OF THE INVENTION

Main object of the present invention is to provide an efficient and economical process for the differentiation of natural products/essential oil products from their synthetic analogues.

Another object of the present invention is to differentiate the pure compounds obtained through crystallization from essential oils against their synthetic analogues.

Yet another object of the present invention is to provide a low-cost and easily available technique of GC-MS for differentiation of pure natural compounds of volatile or semi-volatile nature from its synthetic analogues.

Yet another object of the present invention is to differentiate the plant biosynthesized compounds from their analogues synthesized in the laboratory using petrochemicals as starting materials.

Yet another object of the present invention is to provide GC-MS as an alternative technique vis-a-vis the tedious AMS method for estimating 14C radiocarbon in the samples.

Yet another object of the present invention is to give an easy detection procedure to authenticate the natural products or pure natural crystals being used in Food and Flavour applications.

Yet another objective of the present invention is to clearly differentiate the DSC patterns of natural (−)-menthol and synthesis (−)-menthol.

### BRIEF DESCRIPTION OF THE DRAWINGS

FIG. 1 illustrates the pharmaceutically important stereoisomer of menthol [(1R,2S,5R)-(−)-menthol].

FIG. 2 illustrates marketed menthol samples (S1-A; S1-B; S1-C; S1-D) without p-menthenol moiety (no peak detected in zone, A). Radiocarbon (¹⁴C) dating also supports that the non-natural origin of marketed samples, which lacks ¹⁴C (modern carbon). Ortho-menthan-3-ol is a unique marker for synthetic sample S1-A (RT 26.26 min; Zone B).

FIG. 3 illustrates plant-derived natural menthol with p-menthenol moiety (prominent peak detected at RT, 21.4 min; S1-65 menthol samples obtained directly from natural sources and are well complemented by their strong ¹⁴C signatures in radiocarbon dating.

FIG. 4 illustrates plant-derived natural menthol revealed a gradual decrease in the proportion of p-menthenol (in blue color) with an incremental percentage of marketed menthol sample (S1-C) (1-6%).

FIG. 5 illustrates markers designated for natural and synthetic menthol in the developed GC-MS method.

FIG. 6 illustrates powdered menthol from market samples (S1-A; S1-B; S1-D) showed a sharp peak shape (faster endothermic behaviour) than the crystalline state (broad at base) in DSC.

FIG. 7 illustrates crystalline natural (−)-menthol (S2-S4) recorded with higher melting points in DSC.

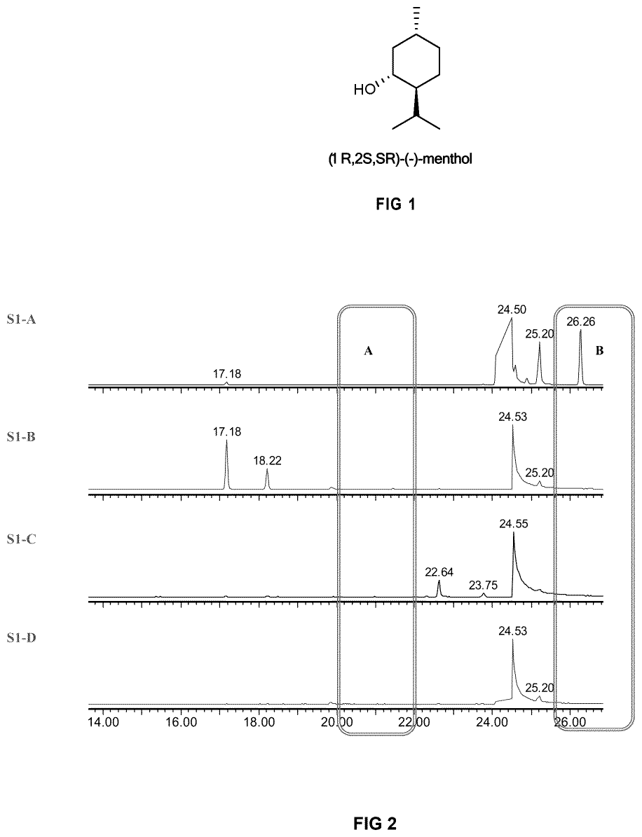

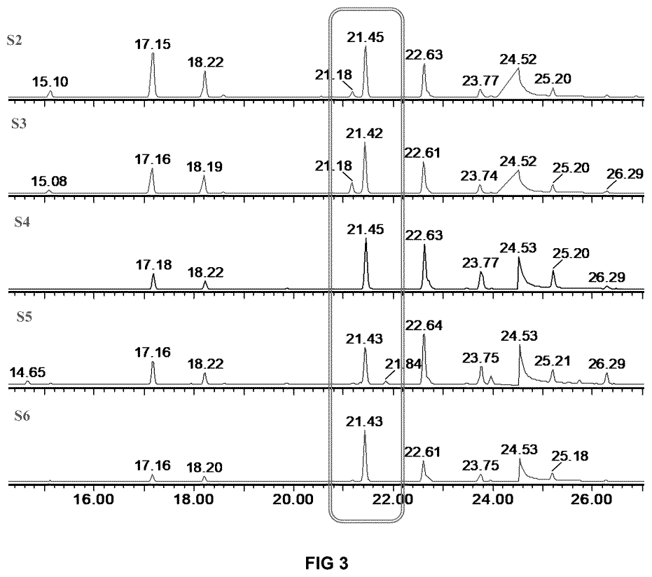

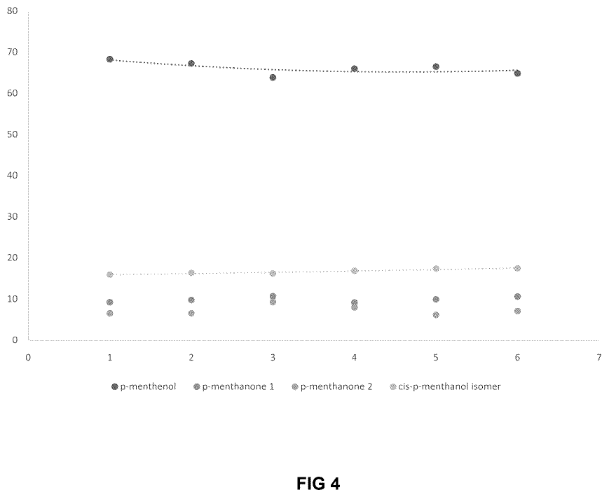

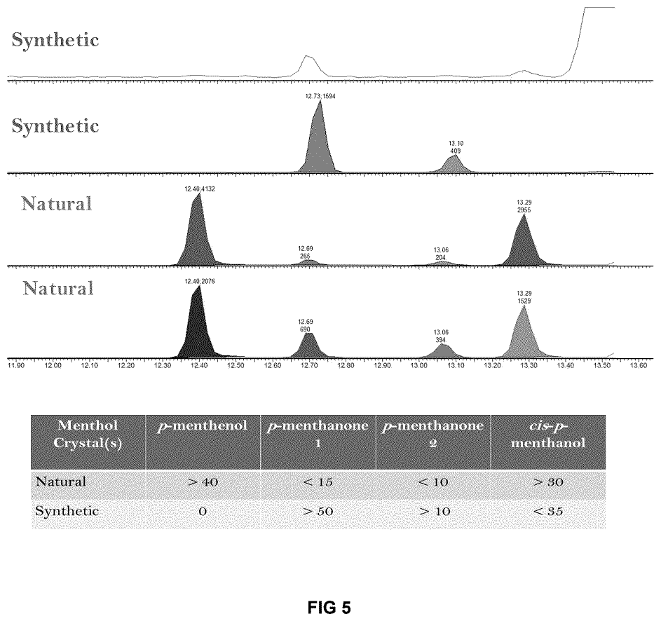

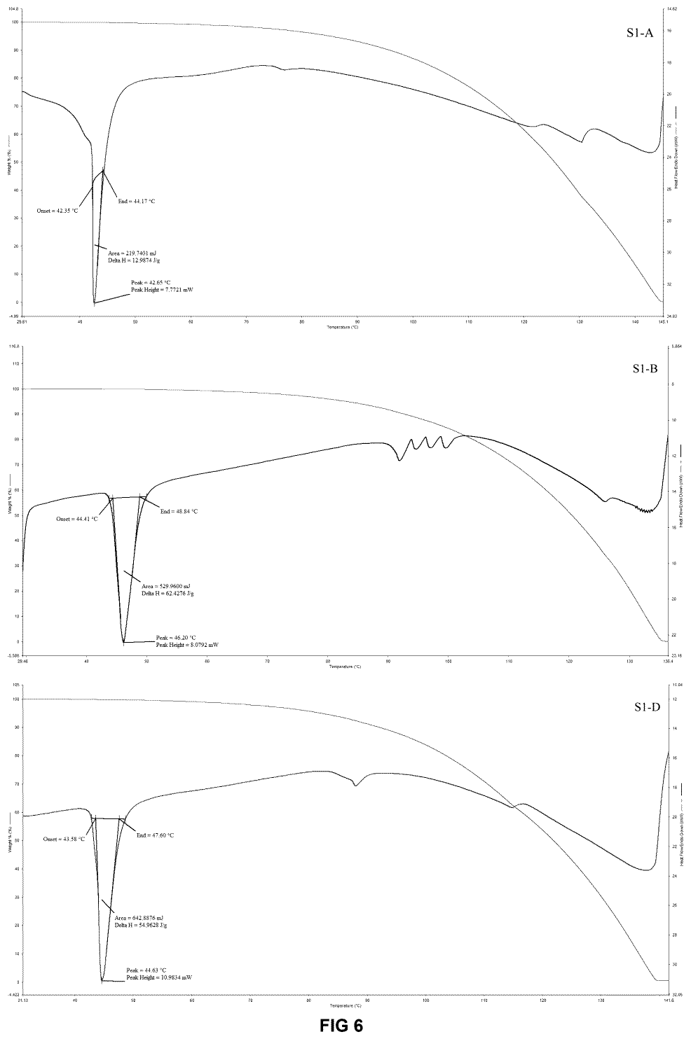

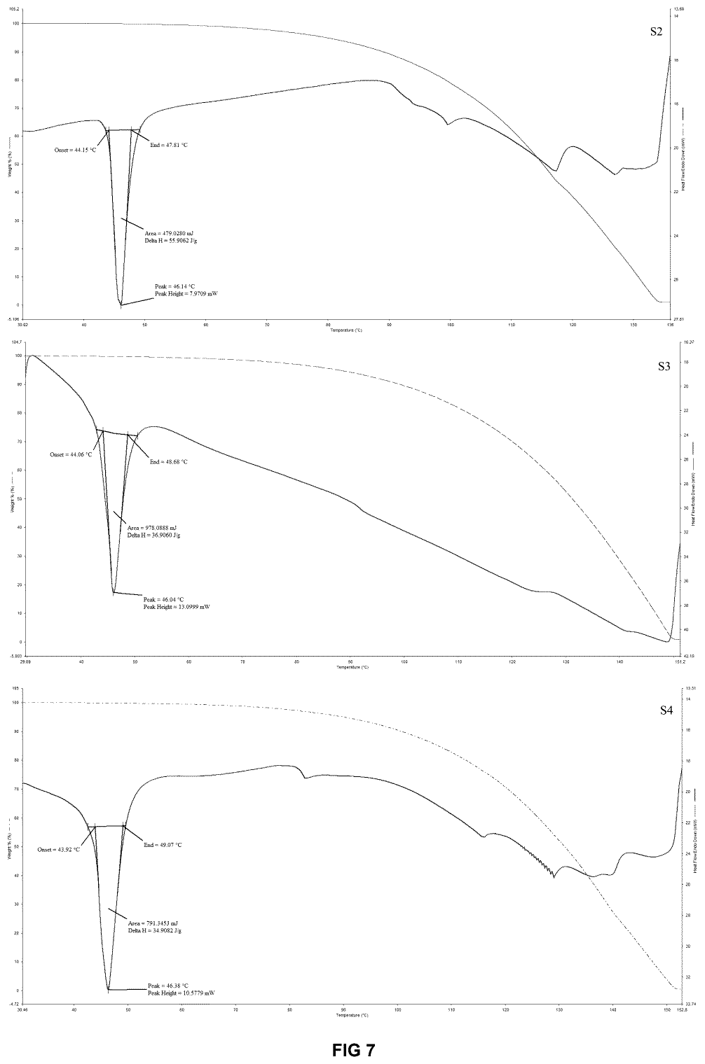

### SUMMARY OF THE INVENTION

prov Accordingly, present invention provides a process for differentiating the natural (−)-menthol from synthetic (−)-menthol comprising the steps of:
i. iding a (−)-menthol sample;
ii. dissolving the (−)-menthol sample in a solvent to obtain a solution;
iii. analysing the solution through gas chromatography-mass spectrometry (GC-MS) in Selected Ion Recording (SIR) mode;
iv. identifying p-menthenol as a unique identifier peak in GC-MS for natural (−)-menthol;
v. identifying ortho-menthan-3-ol and thymol acetate as unique identifiers peak in GC-MS for synthetic (−)-menthol;
vi. analysing the melting point patterns of (−)-menthol sample through DSC (Differential Scanning Calorimeter) curves.

In an embodiment of the present invention, the solvent used is selected from the group consisting of hexane, dichloromethane, methanol and ethanol.

In another embodiment of the present invention, (−)-menthol sample provided is selected from the group consisting of natural (−)-menthol, synthetic (−)-menthol or a mixture thereof.

In yet another embodiment of the present invention, said process shows that natural menthol contains p-menthenol (>40%), p-menthanone 1 (<15%), p-menthanone 2 (<10%) and cis-p-menthanol (>30%).

In yet another embodiment of the present invention, said process shows that synthetic menthol contains p-menthanone-1 (>50%), p-menthanone-2 (>10%) and cis-p-menthanol (<35%).

In yet another embodiment of the present invention, the process distinguishes the origin of natural and synthetic menthol i.e. physical state as crystals or powder is related to the large differences in their melting range in Differential Scanning Calorimeter (DSC).

In yet another embodiment of the present invention, the natural (−)-menthol possessed higher melting point (above 45° C.) in Differential Scanning Calorimeter (DSC).

In yet another embodiment of the present invention, the process identifies
i. presence of p-menthenol in natural menthol;
ii. absence of p-menthenol in synthetic (−)-menthol;
iii. presence of ortho-menthan-3-ol moiety in marketed menthol samples;
iv. absence of stereoisomeric p-menthanone 1, p-menthanone 2, trans-p-menthanol in Pure (−)-menthol synthesized using m-cresol;
v. presence of cis-p-menthanol in Pure (−)-menthol synthesized using citral;
vi. presence of stereoisomeric p-menthanone 1, p-menthanone 2 and stereoisomeric cis- and trans-p-menthanol in natural pure (−)-menthol;
vii. increase in p-menthanone proportions with clear distinction in isomeric ratio of menthanone stereoisomers on the gradual increase of percent of synthetic menthol (5% and 10%) into natural menthol;
viii. decrease in the proportion of p-menthenol on the gradual increase of percent of synthetic menthol (1-6%) into natural menthol;
ix. slight increase (peak enrichment) in the proportion of cis-p-menthanol on the addition of 5-15% of synthetic menthol sample (S1-C) into natural menthol.

### DETAIL DESCRIPTION OF THE INVENTION

Plants are known to be the natural factory for the production of flavor chemicals. Essential oils, a complex mixture, comprise chemicals that differ in terms of a functional group. These oils are utilized for the isolation of biologically active fractions or marker chemicals. Notably, nature-derived aroma chemicals are stereo-chemically specified with definite properties. Some isolated compounds from the essential oils are fine-purified through the crystallization method for use as certified reference materials (CRM).

Since nature-derived aroma chemicals are stereo-chemically specified. Hence, the enantiospecific synthesis and further chiral purification makes synthetic compounds indistinguishable from nature-derived chemicals. For example, on an industrial scale, the menthol synthesis process has been designed using fossil-derived chemicals viz., m-cresol and citral. However, the only renewable process based on natural myrcene as a starting substrate is reported. As a result, the industrial process significantly lowered the cost of production, making a good business profit for International chemical manufacturing companies. The entire Indian mint industry including the mint farming community is facing the challenge of ever-growing import of synthetic menthol into the country. Furthermore, consumer's preference for natural menthol is at stake due to the absence of quantitative traceability tools. From a global perspective, only ¹⁴C-carbon dating process is practiced in differentiating such materials, which requires rigorous and destructive sample preparation techniques including high cost of analysis.

Since there exists readily available efficient processes of these chemicals from high throughout operations at the industrial level; thus, synthetically prepared options have added advantage in mitigating the global gap between supply and demand. For instance, citral is produced on a large scale synthetically from relatively cheap fossil-derived isobutene and formaldehyde.

The present invention provides a process for the differentiation of high-value natural essential oil-based aroma chemicals from synthetic analogues using modified gas chromatography and mass spectroscopy method (GC-MS) [in Selected Ion Recording (SIR) mode] for differentiation of natural origin of aroma chemicals such as menthol (crystals, rice crystals, molten or powder) vis-a-vis its synthetic counterparts.

(−)-Menthol isolated through crystallization is easily distinguished from its synthetic analogues through the mass spectrometric (MS) technique. GC-MS detects specific signatures for differentiating origin-specific bioactive compounds. The different melting patterns of natural and synthetic (−)-menthol complement the GC/MS analysis.

The (−)-menthol of synthetic and natural origin is established through the gas chromatography-mass spectrometry [GC-MS]method. The differentiation has been established through identification of natural markers in trace levels entrapped at the time of crystal formation. The plant-derived natural (−)-menthol with varied physical states (crystals, rice crystals, molten or powder) contained a few oxygenated p-menthane analogues in trace percentage at the time of crystal formation. The natural (−)-menthol crystals are obtained after distilling the menthol mint aerial parts followed by column chromatography separation to get menthol crystals.

Natural (−)-menthol sample has been obtained from the varieties viz., CIM-Unnati, Kosi and CIM-Kranti developed by CSIR-CIMAP using a crystallization process.

The natural (−)-menthol crystals isolated from the Mentha arvensis essential oil were obtained from in-house aroma chemical library of CSIR-CIMAP, Lucknow, Uttar Pradesh, India.

Samples have also been collected from several mint-based industries in India.

Synthetic (−)-menthol is collected from an Indian industry located in U.P, India. (−)-Menthol samples (crystals, rice crystals, molten or powder as the most common physical states) of non-natural origins were collected from M/s Ultra International Pvt Ltd, Ghaziabad, UP.

All the samples were kept in the refrigerator prior to GC-MS analysis and differential calorimetric study (DSC).

The normal GC-MS machine parameters are fixed as per the protocol reported in the menthol analysis. The menthol crystals are solubilized in common organic solvents (mass grade). The spectra of the (−)-menthol are recorded through GC-MS and then analysed. The major (−)-menthol peak is excluded from the analysis so that the traces of marker peaks get enhanced for further identification work. The developed method established the specific markers peaks including the p-menthenol moiety, etc. On the other hand, these moieties are completely absent in samples of non-natural (synthetic) origins.

Differential Scanning Calorimetry (DSC) is another fine technique for giving the exact melting curve of the crystallized samples. Since trace impurities are entrapped in pockets within a crystal structure at the time of crystallization.

Due to the impurity's nature/pattern, the plant-derived and synthesized menthol crystals exhibited differences in their melting curves. The DSC analysis of natural and synthesized samples is well complemented by the developed GC/MS method.

In the present invention, the (−)-menthol samples (crystals, rice crystals, molten or powder) are analysed through differential scanning calorimetry (DSC). The melting point patterns of synthetic and natural (−)-menthol are well differentiated. High melting points were recorded for plant-derived menthol. The recorded difference in melting patterns is based on the rigidity in the crystal as well as the percentage of the traces of markers within the crystal lattice. The distinguished DSC pattern is well complemented by the GC-MS analysis.

### EXAMPLES

Following examples are given by way of illustration and therefore should not be construed to limit the scope of the invention.

### Example 1

The market sample 1 (S1-A) is collected from M/s Ultra International Pvt Ltd, Ghaziabad, UP. The sample (20 mg) was dissolved in dichloromethane, and 1 μL aliquot was injected through an autosampler into the GC-MS injection port. The MS parameters are as follows: The gas chromatography-mass spectrometry (GC-MS) analysis was carried out on a PerkinElmer Clarus 680 GC and SQ8 mass spectrometer with a polar column (30 m length×0.32 mm internal diameter) of 100% polyethylene glycol stationary phase. Helium was used as carrier gas with a flowrate of 1.5 mL/min and a split ratio of 50:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 240° C. The GC-MS interface temperature and ionization source temperature were maintained at 220° C. Separated compounds were ionized at 70 eV and the fragmented ions were scanned in the range of m/z 40 to 500, scan time of 0.8, inter scan delay of 0.01 and dwell time of 0.2 seconds. Two solvent delays at time intervals like 0.0-3.0 min and 23.92-24.43 min were also added in the developed method. Market sample 1 (S1-A) contained Ortho-menthan-3-ol and thymol acetate as unique identifiers, which clarifies that sample S1-A is synthetic in origin. ¹³C NMR signals (125 MHz) recorded for Ortho-menthan-3-ol isolated from synthetic menthol (S1-A) are as follows:
δC 68.91 (CH), 52.25 (CH), 37.05 (CH2), 34.17 (CH2), 31.56 (CH), 28.72 (CH), 21.49(CH3), 20.45 (CH3), 19.74 (CH2), 15.45 (CH3).

Similarly, market samples S1-B; S1-C; S1-D were also collected from M/s Ultra International Pvt Ltd, Ghaziabad, UP. The sample (20 mg each) was dissolved in dichloromethane, and 1 μL aliquot was injected through an autosampler into the GC/MS injection port. The MS parameters are as follows: The gas chromatography-mass spectrometry (GC-MS) analysis was carried out on a PerkinElmer Clarus 680 GC and SQ8 mass spectrometer with a polar column (30 m length×0.32 mm internal diameter) of 100% polyethylene glycol stationary phase. Helium was used as carrier gas with a flow rate of 1.5 mL/min and a split ratio of 50:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 240° C. The GC-MS interface temperature and ionization source temperature were maintained at 220° C. Separated compounds were ionized at 70 eV and the fragmented ions were scanned in the range of m/z 40 to 500, scan time of 0.8, inter scan delay of 0.01 and dwell time of 0.2 seconds. Two solvent delays at time intervals like 0.0-3.0 min and 23.92-24.43 min were also added in the developed method. All three market samples (S1-B; S1-C; S1-D) devoid p-menthenol and revealed their non-natural (synthetic) origin.

### Example 2

Sample 2 (S2) is a laboratory-prepared (−)-menthol obtained from CSIR-CIMAP's menthol mint var. Kosi essential oil. The sample (10 mg) was dissolved in dichloromethane, and 1 μL aliquot was injected through an autosampler into the GC-MS injection port. The MS parameters are as follows: The gas chromatography-mass spectrometry (GC-MS) analysis was carried out on a PerkinElmer Clarus 680 GC and SQ8 mass spectrometer with a polar column (30 m length×0.32 mm internal diameter) of 100% polyethylene glycol stationary phase. Helium was used as carrier gas with a flowrate of 1.5 mL/min and a split ratio of 50:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 240° C. The GC-MS interface temperature and ionization source temperature were maintained at 220° C. Separated compounds were ionized at 70 eV and were scanned in the range of m/z 40 to 500, scan time of 0.8, inter-scan delay of 0.01 and dwell time of 0.2 second. Two solvent delays at time intervals like 0.0-3.0 min and 23.92-24.43 min were also added in the developed method. This natural menthol sample does not possess ortho-menthan-3-ol and thymol acetate. Whereas, the studied sample contained p-menthenol as a unique identifier peak.

### Example 3

Sample 3 (S3) is a laboratory-prepared (−)-menthol obtained from CSIR-CIMAP's menthol mint var. CIM-Unnati essential oil. The sample (20 mg) was dissolved in hexane, and 1 μL aliquot was injected through an autosampler into the GC-MS injection port. The MS parameters are as follows: The gas chromatography-mass spectrometry (GC-MS) analysis was carried out on a PerkinElmer Clarus 680 GC and SQ8 mass spectrometer and Agilent 7010 GC/TQ with 8890 GC system with a non-polar column (30 m length×0.25 mm internal diameter) of 5% diphenyl+95% polydimethylsiloxane as stationary phase. GC inlet temperature was 250° C. and helium was used as carrier gas with a flow rate of 1 mL/min and a split ratio of 60:1. The column oven was programmed from 60° C. to 120° C. at the rate of 3° C./min and upto 240° C. at a ramp rate of 10° C./min with a total GC run time of 32 mins. The GC-MS interface temperature and ionization source temperature were maintained at 220° C. Separated compounds were ionized at 70 eV and the ions were scanned in the mass range of m/z 40 to 500, with scan time of 0.8, inter-scan delay of 0.01 and dwell time of 0.2 second. Two solvent delays at time intervals like 0.0-5.0 min and 14.44-15.44 min were also added in the developed method. The p-menthenol moiety was the key feature for the characterization of natural (−)-menthol.

### Example 4

Sample 4 (S4) is a laboratory-prepared (−)-menthol obtained from CSIR-CIMAP's menthol mint var. CIM-Kranti essential oil. The sample (20 mg) was dissolved in hexane, and 1 μL aliquot was injected through autosampler into the GC-MS injection port. The MS parameters are as follows: The gas chromatography-mass spectrometry (GC-MS) analysis was carried out on a PerkinElmer Clarus 680 GC and SQ8 mass spectrometer and Agilent 7010 GC/TQ with 8890 GC system with a non-polar column (30 m length×0.25 mm internal diameter) of 5% diphenyl+95% polydimethylsiloxane as stationary phase. GC inlet temperature was 250° C. and helium was used as carrier gas with a flow rate of 1 mL/min and a split ratio of 60:1. The column oven was programmed from 60° C. to 120° C. at the rate of 3° C./min and upto 240° C. at a ramp rate of 10° C./min with a total GC run time of 32 mins. The GC-MS interface temperature and ionization source temperature were maintained at 250° C. Separated compounds were ionized at 70 eV and the ions were scanned in the mass range of m/z 40 to 500, with scan time of 0.8, inter-scan delay of 0.01 and dwell time of 0.2 second. Two solvent delays at time intervals like 0.0-5.0 min and 14.44-15.44 min were also added in the developed method. The p-menthenol moiety was the key feature for the characterization of natural (−)-menthol.

### Example 5

Sample 5 (S5) is a laboratory-prepared (−)-menthol from Mentha arvensis essential oil. The sample (20 mg) was dissolved in hexane, and 1 μL aliquot was injected through an autosampler into the GC-MS injection port. The MS parameters are as follows: The gas chromatography-mass spectrometry (GC-MS) analysis was carried out on a PerkinElmer Clarus 680 GC and SQ8 mass spectrometer with a non-polar column (30 m length×0.25 mm internal diameter) of 5% diphenyl+95% polydimethylsiloxane as stationary phase. GC inlet temperature was 250° C. and helium was used as carrier gas with a flow rate of 1 mL/min and a split ratio of 60:1. The column oven was programmed from 60° C. to 120° C. at the rate of 3° C./min and upto 240° C. at a ramp rate of 10° C./min with a total GC run time of 32 mins. The GC-MS interface temperature and ionization source temperature were maintained at 300° C. Separated compounds were ionized at 70 eV and the ions were scanned in the mass range of m/z 40 to 500, with a scan time of 0.8, inter-scan delay of 0.01 and dwell time of 0.2 seconds. Two solvent delays at time intervals like 0.0-5.0 min and 14.44-15.44 min were also added in the developed method. The p-menthenol moiety; and stereoisomeric p-menthanone monoterpenes (1 & 2) were the features for the characterization of natural (−)-menthol.

### Example 6

Sample 6 (S6) is a laboratory-prepared (−)-menthol from Mentha arvensis essential oil. The sample (20 mg) was dissolved in pentane, and 1 μL aliquot was injected through an autosampler into the GC-MS injection port. The MS parameters are as follows: GC-MS analysis was carried out on a PerkinElmer Clarus 680 GC and SQ8 mass spectrometer with a capillary column (30 m length×0.32 mm internal diameter) of polyethylene glycol stationary phase. Helium was used as carrier gas with a flowrate of 1.5 mL/min and a split ratio of 50:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 240° C. The GC-MS interface temperature and ionization source temperature were maintained at 220° C. Separated compounds were ionized at 70 eV and the ions were scanned in the range of m/z 40 to 500, scan time 0.8, inter-scan delay 0.01 and dwell time of 0.2 second. Two solvent delays at time intervals like 0.0-3.0 min and 23.92-24.43 min were also added in the developed method. The stereoisomeric p-menthanone monoterpenes (1 & 2) are the feature for the characterization of natural (−)-menthol. p-Menthenol moiety and stereoisomeric p-menthanone monoterpenes (1 & 2) were distinct features of natural (−)-menthol.

### Example 7

Sample 6 is a mixture of natural (−)-menthol (90%) and 10% synthetic (−)-menthol (wt/wt basis). The sample (40 mg) was dissolved in pentane, and 1 μL aliquot was injected through an autosampler into the GC-MS injection port. The MS parameters as follows: GC-MS analysis was carried on a PerkinElmer Clarus 680 GC and SQ8 mass spectrometer with a semi-standard non-polar column (30 m length×0.25 mm internal diameter) of 5% phenyl+95% polydimethylsiloxane stationary phase. Helium was used as carrier gas with a flowrate of 1 mL/min and a split ratio of 100:1. The column oven was programmed from 60° C. to 240° C. at the rate of 3° C./min. The inlet temperature was maintained at 290° C. The GC-MS interface temperature and ionization source temperature were maintained at 220° C. Separated compounds were ionized at 70 eV and the ions were scanned in the range of m/z 40 to 500, scan time of 0.8, inter-scan delay of 0.01 and dwell time of 0.2 second. The stereoisomeric p-menthanone monoterpenes are the feature for the characterization of synthetic (−)-menthol. p-Menthenol moiety and stereoisomeric p-menthanone monoterpenes are distinct features of natural (−)-menthol. The ratio of p-menthanone monoterpenes (1 & 2) is giving adulteration range around 10% (table 2).

### Example 8

Sample 6 is a mixture of natural (−)-menthol (50%) and 50% synthetic (−)-menthol. The sample (40 mg) was dissolved in dichloromethane, and 1 μL aliquot was injected through an autosampler into the GC-MS injection port. The MS parameters are as follows: GC-MS analysis was carried out on a PerkinElmer Clarus 680 GC and SQ8 mass spectrometer with a capillary column (30 m length×0.32 mm internal diameter) of polyethylene glycol stationary phase. Helium was used as carrier gas with a flowrate of 1.5 mL/min and a split ratio of 50:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 240° C. The GC-MS interface temperature was kept at 200° C. and the ionization source temperature was maintained at 180° C. Separated compounds were ionized at 70 eV and the ions were scanned in the range of m/z 40 to 500, scan time of 0.8, inter-scan delay of 0.01 and dwell time of 0.2 seconds. Two solvent delays at time intervals like 0.0-3.0 min and 23.92-24.43 min were also added in the developed method. The stereoisomeric p-menthanone monoterpenes are the feature for the characterization of natural synthetic (−)-menthol. p-Menthenol moiety and stereoisomeric p-menthanone monoterpenes (1 & 2) are distinct features of natural (−)-menthol. The ratio of p-menthanone monoterpenes (1 & 2) is giving adulteration range around 50% (table 2).

### Example 9

Sample 6 is a mixture of natural (−)-menthol (80%) and 20% synthetic (−)-menthol. The sample (40 mg) was dissolved in dichloromethane, and injected through autosampler into the GC-MS injection port. The MS parameters are as follows: GC-MS analysis was carried out on a PerkinElmer Clarus 680 GC and SQ8 mass spectrometer with a capillary column (30 m length×0.32 mm internal diameter) of polyethylene glycol stationary phase. Helium was used as carrier gas with a flowrate of 1.7 mL/min and a split ratio of 80:1. The column oven was programmed from 40° C. to 120° C. at the rate of 3° C./min and kept isothermal at 120° C. for 9 mins. The oven temperature was further increased at the rate of 2° C./min from 120° C. to 140° C. (hold for 2 mins) and increased at the rate of 5° C./min to 230° C. (hold for 2 mins). The inlet temperature was maintained at 250° C. The GC-MS interface temperature was kept at 260° C. and the ionization source temperature was maintained at 260° C. Separated compounds were ionized at 70 eV and the ions were scanned in the range of m/z 40 to 500, scan time of 0.8, inter-scan delay of 0.01 and dwell time of 0.2 second. Two solvent delays at time intervals like 0.0-3.0 min and 23.92-24.43 min were also added in the developed method. The stereoisomeric p-menthanone monoterpenes are the feature for the characterization of synthetic (−)-menthol. p-Menthenol moiety and stereoisomeric p-menthanone monoterpenes (1 & 2) are distinct features of natural (−)-menthol. The ratio of p-menthanone monoterpenes (1 & 2) is giving adulteration range around 20% (table 2).

### Example 10

Sample 7 is a laboratory-prepared (−)-menthol from Mentha arvensis essential oil. The sample (40 mg) was dissolved in dichloromethane, and injected through autosampler into the GC-MS injection port. The MS parameters are as follows: GC-MS analysis was carried out on a PerkinElmer Clarus 680 GC and SQ8 mass spectrometer with a capillary column (30 m length×0.32 mm internal diameter) of polyethylene glycol stationary phase. Helium was used as carrier gas with a flowrate of 1.5 mL/min and a split ratio of 80:1. The column oven was programmed from 40° C. to 120° C. at the rate of 3° C./min and kept isothermal at 120° C. for 2 mins. The oven temperature was further increased at the rate of 10° C./min to 240° C. The inlet temperature was maintained at 240° C. The GC-MS interface temperature was kept at 240° C. and the ionization source temperature was maintained at 240° C. Separated compounds were ionized at 70 eV and the ions were scanned in the range of m/z 40 to 500, scan time of 0.8, inter scan delay of 0.01 and dwell time of 0.2 second. Two solvent delays at time intervals like 0.0-3.0 min and 23.87-24.37 min were also added in the developed method. The stereoisomeric p-menthanone monoterpenes (1 & 2) are the feature for the characterization of synthetic (−)-menthol. p-Menthenol moiety and stereoisomeric p-menthanone monoterpenes (1 & 2) were distinct features of natural (−)-menthol.

Table 2 shows gradual change in proportions of marker constituents after addition of fossil-derived menthol in natural menthol.

TABLE 2

| | | Percentage Values | | | | Standard deviation | | | |
|---|---|---|---|---|---|---|---|---|---|
| | Natural | C1 | C2 | C3 | C4 | C1 | C2 | C3 | C4 |
| 50b | 100% | 35.14 | 2.08 | 1.19 | 61.59 | 0.9736 | 0.1023 | 0.0075 | 1.0064 |
| 40b:10a | 80% | 35.30 | 4.67 | 2.22 | 57.81 | 0.2877 | 0.1051 | 0.0651 | 0.4251 |
| 30b:20a | 60% | 31.92 | 10.54 | 4.40 | 53.14 | 0.3104 | 0.1446 | 0.1262 | 0.5361 |
| 20b:30a | 40% | 33.54 | 10.40 | 2.64 | 53.42 | 0.2956 | 0.2084 | 0.0938 | 0.4016 |
| 10b:40a | 20% | 29.80 | 18.76 | 3.33 | 48.11 | 0.5834 | 0.1788 | 0.2953 | 0.3659 |
| 50a | 0% | 2.70 | 69.71 | 9.24 | 18.35 | 0.1847 | 0.4807 | 0.6407 | 0.3367 |

C1: p-menthenol; C2 & C3: stereoisomeric p-menthanone 1 & 2; C4: cis-p-menthanol.
aSynthetic menthol (wt/wt); bNatural menthol (wt/wt).

### Advantages of the Invention

The developed GC/MS process is easy, low cost and less time consuming technique.
Gas chromatography-mass spectrometry detects specific signatures for differentiating origin specific pure (−)-menthol crystals.
GC/MS modified analytical technique is robust, economical and quick in differentiating the natural (−)-menthol from synthetic (−)-menthol derived from different routes with easy sample preparation technique.
The GC/MS modified analysis and DSC patterns clearly distinguish the natural and synthetic (−)-menthol, and both analysis are complementary to one another.
After the completion of the sample run or analysis; either synthetic (−)-menthol, natural (−)-menthol or a mixture of both, the GC/MS machine is ready for the next analysis within five minutes.

We claim:

1. A process for differentiating the natural (−)-menthol from synthetic (−)-menthol comprising the steps of:
i. providing a (−)-menthol sample;
ii. dissolving the (−)-menthol sample in a solvent to obtain a solution;
iii. analysing the solution through gas chromatography-mass spectrometry (GC-MS) in Selected Ion Recording (SIR) mode;
iv. identifying p-menthenol as a unique identifier peak in GC-MS for natural (−)-menthol;
v. identifying ortho-menthan-3-ol and thymol acetate as unique identifiers peak in GC-MS for synthetic (−)-menthol;
vi. analysing the melting point patterns of (−)-menthol sample through DSC (Differential Scanning Calorimeter) curves.

2. The process as claimed in claim 1, wherein the solvent used is selected from the group consisting of hexane, dichloromethane, methanol and ethanol.

3. The process as claimed in claim 1, wherein (−)-menthol sample provided is selected from the group consisting of natural (−)-menthol, synthetic (−)-menthol or a mixture thereof.

4. The process as claimed in claim 1, wherein said process shows that natural menthol contains p-menthenol (>40%), p-menthanone 1 (<15%), p-menthanone 2 (<10%) and cis-p-menthanol (>30%).

5. The process as claimed in claim 1, wherein said process shows that synthetic menthol contains p-menthanone-1 (>50%), p-menthanone-2 (>10%) and cis-p-menthanol (<35%).

6. The process as claimed in claim 1, wherein the process distinguishes the origin of natural and synthetic menthol i.e. physical state as crystals or powder is related to the large differences in their melting range in Differential Scanning Calorimeter (DSC).

7. The process as claimed in claim 1, wherein the natural (−)-menthol possessed higher melting point (above 45° C.) in Differential Scanning Calorimeter (DSC).

8. The process as claimed in claim 1, wherein the process identifies
i. presence of p-menthenol in natural menthol;
ii. absence of p-menthenol in synthetic (−)-menthol;
iii. presence of ortho-menthan-3-ol moiety in marketed menthol samples;
iv. absence of stereoisomeric p-menthanone 1, p-menthanone 2, trans-p-menthanol in Pure (−)-menthol synthesized using m-cresol;
v. presence of cis-p-menthanol in Pure (−)-menthol synthesized using citral;
vi. presence of stereoisomeric p-menthanone 1, p-menthanone 2 and stereoisomeric cis- and trans-p-menthanol in natural pure (−)-menthol;
vii. increase in p-menthanone proportions with clear distinction in isomeric ratio of menthanone stereoisomers on the gradual increase of percent of synthetic menthol (5% and 10%) into natural menthol;
viii. decrease in the proportion of p-menthenol on the gradual increase of percent of synthetic menthol (1-6%) into natural menthol;
ix. slight increase (peak enrichment) in the proportion of cis-p-menthanol on the addition of 5-15% of synthetic menthol sample (S1-C) into natural menthol.
